(19) United States
(12) Patent Application Publication
(10) Pub. No.: US 2002/0083958 A1
(43) Pub. Date: Jul. 4, 2002

(54) Small parts cleaner

(76) Inventor: Mario E. Bran, Garden Grove, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/916,357

(22) Filed: Jul. 27, 2001

Related U.S. Application Data
(60) Provisional application No. 60/221,089, filed on Jul. 27, 2000.

(51) Int. Cl. B08B 3/12

(52) U.S. Cl. 134/1; 134/25.4; 134/104.4; 134/104.3

(57) ABSTRACT

An apparatus for separating contaminants from small parts comprises a separation chamber having an upper end and a lower end, and a separation-fluid source in fluid communication with the separation chamber. The separation-fluid source is adapted to direct a pressurized separation-fluid current toward the upper end of the separation chamber. The upper end of the separation chamber has an opening for receiving the small parts, so that the small parts, upon passing through the opening, will fall toward the lower end of the separation chamber against the separation-fluid current while the separation-fluid current removes the contaminants from the small parts and carries the contaminants out of the separation chamber via the upper end of the separation chamber. A method of cleaning contaminants from small parts comprises causing the small parts to fall toward the lower end of a cleaning chamber against a generally upwardly-directed pressurized cleaning-fluid flow located within the cleaning chamber, and separating the contaminants from the small parts by permitting the cleaning-fluid flow to remove the contaminants from the small parts and carry the contaminants toward the upper end of the cleaning chamber.

### BACKGROUND OF THE INVENTION

1. Field of the Invention

This invention relates to a system for cleaning small parts, the system being particularly useful for cleaning parts requiring a high degree of cleanliness.

2. Description of the Related Art

Small components or parts of electronic devices often require high cleanliness levels. As one example, information stored on computer disks is typically read by a magnetic head that includes a small pick-up, referred to as a slider. The slider is mounted on the end of a support arm and positioned above a rotating disk. The sliders are made in various sizes, one type being in the form of a flat, thin element less than ⅛″ square. It is necessary that the cleaning include the removal of small particles on the sliders. In addition to providing an adequate cleaning capability, the system must be practical from a cost standpoint in that large quantities of these sliders are utilized.

There are of course many other examples of small parts needing exceptional cleanliness, ball bearings for example.

### SUMMARY OF THE INVENTION

In accordance with the invention, small elements, such as the lightweight sliders referred to above, are introduced one or more at a time into the upper end of a small diameter tube or chamber to fall under the force of gravity. Cleaning fluid is pumped upwardly through the tube, thus encountering and cleaning the falling elements. The cleaning fluid overflows the open upper end of the tube carrying with it the material removed from the parts. The clean elements fall from the lower end of the tube, as a gate or valve in the lower end is periodically opened. Because the elements are wet from the cleaning fluid, they are then dried by a suitable means, such as an inert gas.

To enhance the cleaning operation, megasonic energy is applied to the fluid flowing upwardly in the central tube. This energy agitates particles on the elements to facilitate their removal. The megasonic energy is provided by one or more piezoelectric transducers coupled to the exterior of a cylinder spaced from but surrounding the central cleaning tube. A liquid coolant is pumped upwardly through the annular space between the tube and the cylinder, and allowed to overflow at the upper end. The megasonic energy is transmitted through the walls of the cylinder, through the liquid in the space between the cylinder and the inner tube, through the wall of the inner tube and into the cleaning fluid within the inner tube. The energy from the transducers is directed toward the center of the inner tube. This produces considerable agitation along the central axis which is the area in which the elements to be cleaned fall through the tube and the cleaning fluid.

A tubular housing spaced from and surrounding and protecting the transducers is desirable. Air or other gas is provided in the space between the outer housing and the transducers in that megasonic energy is not transmitted readily outwardly through the gas. If desired, a continuous stream of gas can be employed to provide further cooling of the transducers and purging of that area.

In accordance with one embodiment, an apparatus for separating contaminants from small parts comprises a separation chamber having an upper end and a lower end, and a separation-fluid source in fluid communication with the separation chamber. The separation-fluid source is adapted to direct a pressurized separation-fluid current toward the upper end of the separation chamber. The upper end of the separation chamber has an opening for receiving the small parts, so that the small parts, upon passing through the opening, will fall toward the lower end of the separation chamber against the separation-fluid current while the separation-fluid current removes the contaminants from the small parts and carries the contaminants out of the separation chamber via the upper end of the separation chamber.

In accordance with another embodiment, a cleaning apparatus comprises a cleaning chamber having an upper end and a lower end, and a pressurized cleaning-fluid flow located in the cleaning chamber. The cleaning-fluid flow is directed toward the upper end of the cleaning chamber, and exits from the upper end of the cleaning chamber. The upper end of the cleaning chamber has an opening for receiving a supply of elements to be cleaned, and the cleaning-fluid flow permits the elements to fall toward the lower end of the chamber, removes contaminants from the elements and carries the contaminants out of the cleaning chamber via the upper end.

In accordance with still another embodiment, a method of cleaning contaminants from small parts comprises causing the small parts to fall toward the lower end of a cleaning chamber against a generally upwardly-directed pressurized cleaning-fluid flow located within the cleaning chamber, and separating the contaminants from the small parts by permitting the cleaning-fluid flow to remove the contaminants from the small parts and carry the contaminants toward the upper end of the cleaning chamber.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is a schematic illustration of a cleaning system incorporating the invention;

FIG. 2 is a cross-sectional schematic view of the apparatus of FIG. 1; and

FIG. 3 is a cross-sectional view of a further embodiment of the apparatus of FIG. 1.

### DETAILED DESCRIPTION OF THE PREFERRED EMBODIMENT

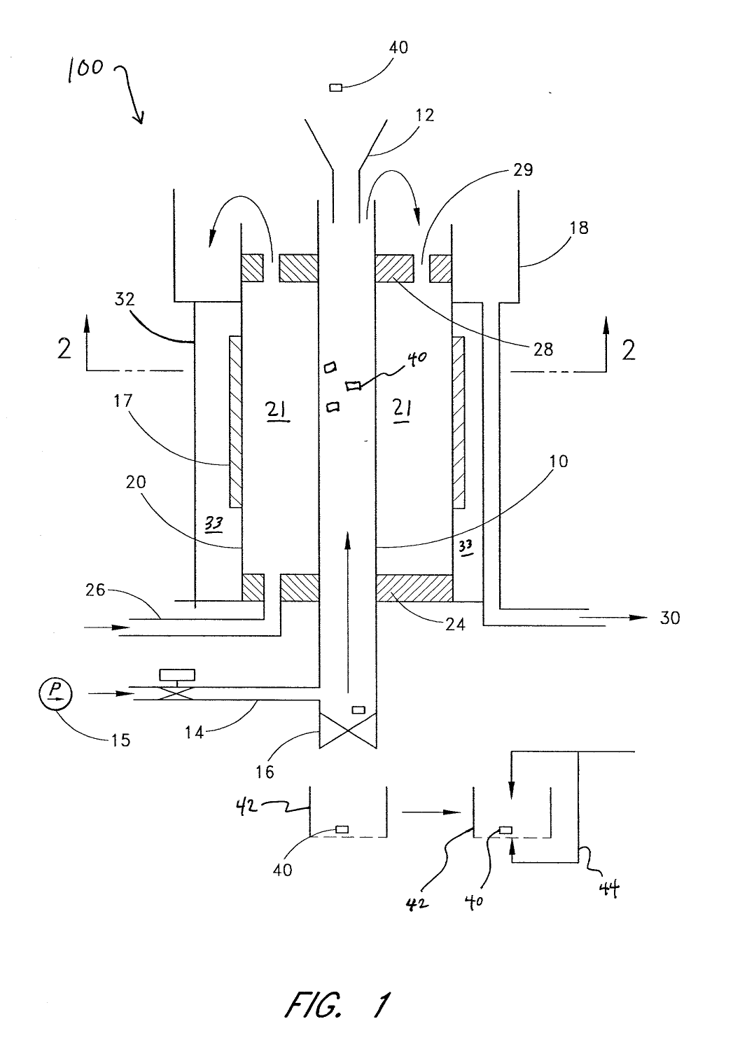

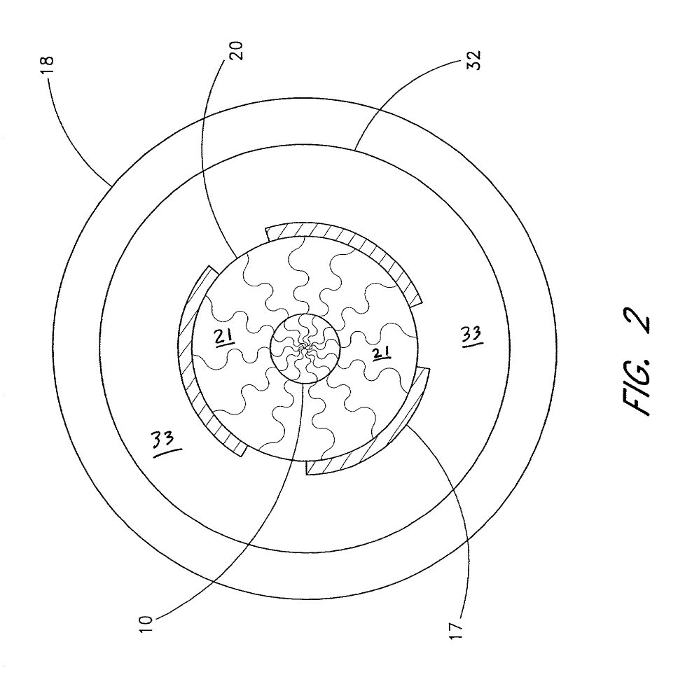

Referring to the schematic illustrations of FIGS. 1 and 2, there is shown a cleaning apparatus 100 having an inner, cleaning/separation tube 10. The terms “cleaning chamber” or “separation chamber” will also be used in referring to the tube 10 depicted in FIG. 1, as it will become clear that the functions of the tube 10 can be accomplished with other, non-tubular shapes, and the term “chamber” is intended to encompass all such shapes, of which a tube is only one example. A funnel or other input device 12 is shown with its lower end extending loosely into the upper end of the cleaning chamber so that liquid may overflow the upper end of the chamber. A cleaning/separation fluid inlet conduit 14 opens into the lower end of the cleaning chamber 10 and is connected to a pump 15 or other source of pressurized cleaning/separation fluid to be pumped upwardly through the chamber 10. A gate or valve 16 is shown at the lower end of the cleaning chamber below the inlet for the cleaning fluid.

Spaced from and surrounding the cleaning chamber 10 is a casing 20 having one or more piezoelectric transducers 17 acoustically coupled to the exterior of the casing by suitable means known in the prior art. In one approach, the transducers may be bonded to the cylinder by a suitable bonding material. The casing 20 defines a coolant chamber 21 surrounding the cleaning chamber 10. In the illustrated embodiment, the casing 20 (and the coolant chamber 21 defined thereby) is cylindrical and the transducers 17 are curved to closely fit the curved surface of the casing. Experience has thus far revealed that the generally circular configuration illustrated in FIGS. 1 and 2 is particularly useful for focusing or directing the megasonic energy emitted by the transducers 17 into the cleaning chamber 10, as will be explained in greater detail below. However, other cross-sectional shapes are possible for the casing and transducers, such as a square, rectangle, oval, etc.

A lower end wall 24, which is annular in shape where the casing 20 is circular, surrounds the cleaning chamber 10 and closes the lower end of the coolant chamber 21. A coolant inlet 26 is schematically shown leading through the lower end wall 24 into the coolant chamber 21. A similar upper end wall 28 closes the upper end of the coolant chamber 21 and surrounds the cleaning chamber 10 as it protrudes through the upper end wall. One or more openings 29 are formed in the upper end wall 28 so that coolant pumped upwardly through the upper wall 28 can overflow the cylinder and flow into the weir 18 which has an outlet 30 leading to a suitable drain.

To protect and isolate the transducers and their electrical connections, an outer cylindrical shell or housing 32 is concentrically positioned around the transducers and the cylinder 20, thereby defining a transducer chamber 33. As with the casing 20 described above, the housing 32 can take on a variety of cross-sectional shapes, but the cylindrical shape depicted in FIGS. 1 and 2 is the presently preferred configuration. Air or other gas occupies the transducer chamber 33 and can be pumped or otherwise circulated through the chamber 33 to provide further cooling of the transducers 17.

In use, the parts to be cleaned, such as the small sliders 40, referred to above, are introduced one or more at a time into the upper end of the funnel 12 or cleaning chamber 10 and fall under the force of gravity through the chamber 10, toward its lower end. At the same time, a suitable cleaning fluid, such as, for example, deionized water, is pumped toward the upper end of the chamber 10, thus forming a contained, pressurized flow or current of cleaning fluid. This cleaning-fluid flow/current advances generally axially and upwardly within the cleaning chamber 10, and engages the sliders as they fall toward the lower end of the chamber 10, thus performing a cleaning operation. Contaminants removed from these sliders 40 can flow upwardly with the cleaning fluid that overflows the upper end of the cleaning tube 10. In other words, the flow/current of cleaning fluid removes the contaminants from the sliders and carries the contaminants up and out of the chamber 10, thereby separating the contaminants from the sliders. The generally upward flow of the cleaning fluid regulates the speed of the falling sliders 40 and thus can be adjusted to experimentally determine the desired flow to produce the proper cleaning.

To enhance the cleaning operation, the piezoelectric transducers 17 direct megasonic energy inwardly (as best seen in FIG. 2), focusing it near the center of the cleaning chamber 10 and thus into the area in which the parts to be cleaned are falling. As one example, about 150 watts per transducer may be applied to them to produce megasonic energy having a frequency of about 840 kilohertz. The transducers generate heat. A liquid, such as water, forms a good heat exchanger and is also desirable for conducting megasonic energy through the coolant chamber 21 to the walls of the cleaning chamber 10. Thus, the coolant flowing in the coolant chamber 21 between the cleaning chamber 10 and the casing 20 conveniently forms a dual purpose, serving both as a coolant and an energy coupling fluid.

Once cleaned, the parts can be collected in the bottom of the cleaning chamber 10. However, it will be necessary to remove those parts. This can be done by periodically quickly opening and closing the gate/valve 16 at the bottom of the chamber 10, allowing the parts to fall into a suitable container or other suitable means. If necessary, a second valve can be provided above the (lower) gate/valve 16 to minimize the flow of cleaning fluid downwardly when the lower gate 16 is opened. A basket 42 or other suitable slider catching device may be provided beneath the lower gate 16.

Since the parts to be cleaned are wet to some extent when upon removal from the cleaning chamber 10, the parts may be moved to a suitable apparatus for drying, such as one employing a hot or cold nitrogen blow-off process 44. Alternatively, a drying mechanism may possibly be included with the basket 42 or other device which catches the parts as they fall out of the cleaning chamber.

While the invention is readily understood from the above description, it can be appreciated that due to the schematic illustration, many variations and modifications can be made to the system and yet fall within the scope of the invention.

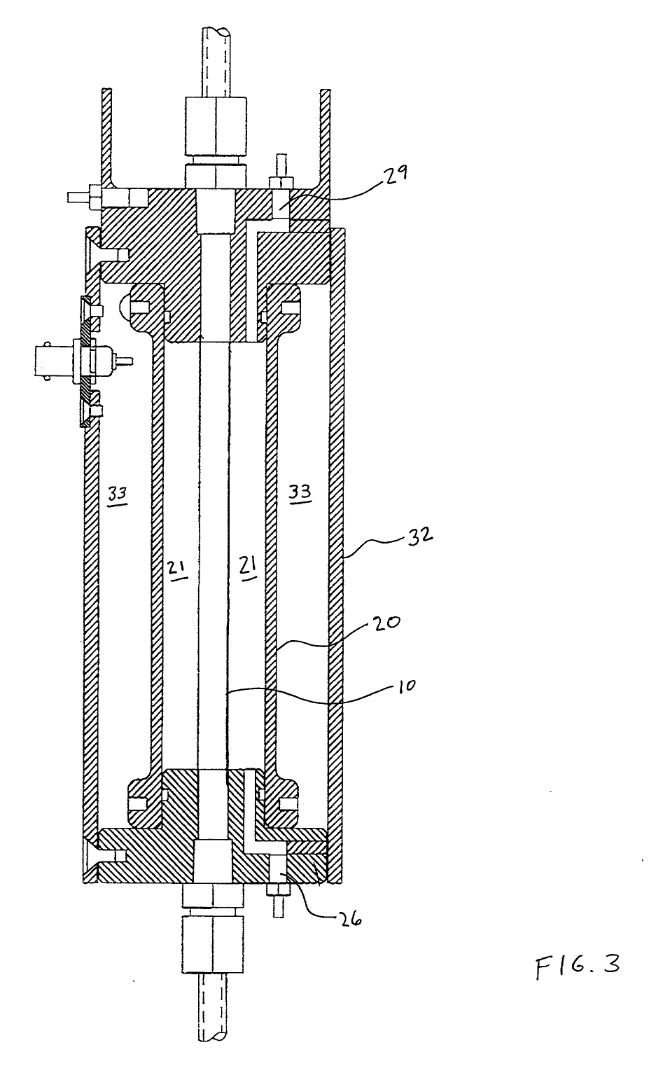

In one prototype of the system, shown in FIG. 3, a thin walled inner/cleaning tube 10 of about ⅜ inch diameter was employed, with a surrounding casing 20 of about 1 and ⅜ inch diameter and a wall thickness of about 0.15 inches. The assembly was about 8 inches in height.

In general, the walls of the tubes/chambers disposed between the transducers and the interior of the cleaning tube are preferably as thin as possible to enhance transmission of the sonic energy. On the other hand, a tube/chamber wall having a thickness approximately equal to half the wavelength of the applied megasonic energy is practical.

The cleaning tube/chamber, as well as the other tubes/chambers, may be made of whatever material is suitable, taking into consideration the parts being cleaned, the cleaning liquid being employed, and the desired cleanliness level. For example, the cleaning tube/chamber might be made of aluminum, Teflon, quartz, sapphire, or graphite coated with silicon carbon or vitreous carbon.

While the system is illustrated in FIG. 2 with three transducers 17, it is possible to use only one or two transducers, as an alternative. Further, where more than one is employed, the transducers can be energized in sequence, or in pairs, etc., as desired to provide effective cleaning.

The cleaning tube/chamber is illustrated in the Figures as having a vertical orientation, but as an alternative it could be operated in a tilted orientation or positioned horizontally to further control the rate of movement of the parts being cleaned.

What is claimed is:

1. An apparatus for separating contaminants from small parts, comprising:
a separation chamber having an upper end and a lower end; and
a separation-fluid source in fluid communication with said separation chamber and adapted to direct a pressurized separation-fluid current toward said upper end of said separation chamber;
wherein said upper end of said separation chamber has an opening for receiving said small parts, so that said small parts, upon passing through said opening, will fall toward said lower end of said separation chamber against said separation-fluid current while said separation-fluid current removes said contaminants from said small parts and carries said contaminants out of said separation chamber via said upper end of said separation chamber.

2. The apparatus of claim 1, further comprising at least one megasonic transducer operatively associated with said separation chamber, said megasonic transducer being adapted to create a megasonic energy field in said separation chamber.

3. The apparatus of claim 2, further comprising a coolant chamber disposed between said megasonic transducer and said separation chamber.

4. The apparatus of claim 1, further comprising a gate at said lower end of said separation chamber, said gate being adapted to provide access to said elements upon their collection at said lower end of said separation chamber.

5. The apparatus of claim 1, wherein said separation chamber comprises a tube.

6. The apparatus of claim 1, wherein said separation-fluid current flows generally axially in said separation chamber.

7. The apparatus of claim 1, wherein said separation chamber is oriented generally vertically.

8. The apparatus of claim 1, wherein said separation chamber is tilted.

9. A cleaning apparatus, comprising:
a cleaning chamber having an upper end and a lower end;
a pressurized cleaning-fluid flow located in said cleaning chamber, said cleaning-fluid flow being directed toward said upper end of said cleaning chamber, said cleaning-fluid flow exiting from said upper end of said cleaning chamber;
wherein said upper end of said cleaning chamber has an opening for receiving a supply of elements to be cleaned, and said cleaning-fluid flow permits said elements to fall toward said lower end of said chamber, removes contaminants from said elements and carries said contaminants out of said cleaning chamber via said upper end.

10. The cleaning apparatus of claim 9, further comprising a megasonic energy field in said cleaning chamber.

11. The cleaning apparatus of claim 9, wherein said cleaning-fluid flow also permits said elements to collect at said lower end of said cleaning chamber while carrying said contaminants out of said cleaning chamber via said upper end.

12. The cleaning apparatus of claim 11, further comprising a gate at said lower end of said cleaning chamber, said gate being adapted to provide access to said elements upon their collection at said lower end of said cleaning chamber.

13. The cleaning apparatus of claim 9, further comprising at least one megasonic transducer operatively associated with said cleaning chamber, said megasonic transducer being adapted to create a megasonic energy field in said cleaning chamber.

14. The cleaning apparatus of claim 13, further comprising a coolant chamber disposed between said megasonic transducer and said cleaning chamber.

15. The cleaning apparatus of claim 9, wherein said cleaning-fluid flow is directed generally axially in said cleaning chamber.

16. The cleaning apparatus of claim 9, wherein said cleaning chamber comprises a tube.

17. The cleaning apparatus of claim 9, wherein said cleaning chamber is oriented generally vertically.

18. The cleaning apparatus of claim 9, wherein said cleaning chamber is tilted.

19. A method of cleaning contaminants from small parts, the method comprising:
causing said small parts to fall toward the lower end of a cleaning chamber against a generally upwardly-directed pressurized cleaning-fluid flow located within the cleaning chamber, and separating said contaminants from said small parts by permitting said cleaning-fluid flow to remove said contaminants from said small parts and carry said contaminants toward the upper end of said cleaning chamber.

20. The method of claim 19, further comprising generating a megasonic energy field in said cleaning chamber.
